(19) United States
(12) Patent Application Publication
(10) Pub. No.: US 2008/0089016 A1
(43) Pub. Date: Apr. 17, 2008

(54) Industrial computer casing

(76) Inventor: Wei-Ping Chen, Taipei (TW)

Correspondence Address: WEI-PING CHEN, 235 Chung-Ho, Box 8-24, Taipei, TW, omitted

(21) Appl. No.: 11/581,532

(22) Filed: Oct. 17, 2006

(51) Int. Cl. H02B 1/00

(52) U.S. Cl. 361/600

(57) ABSTRACT

An industrial computer casing comprises a seat; a front frame at a front side of the seat and formed with a frame hole and a long hole at an upper side of the frame hole; a door plate covering upon a front end of the front frame; the door plate having a plurality of via holes; a tray installed with a data processing unit; the tray passing through the long hole and running across the frame supporter and the supporting plate so as to be positioned at an upper front side of the casing; and a back plate at a backside of the seat; a mother board installed on the seat and in an open space between the frame supporter and the back plate; and an upper cover covering upon the seat.

### FIELD OF THE INVENTION

The present invention relates to computer casings, and particularly to an industrial computer casing, wherein the fan module can guide exterior cool air to the motherboard and then flow out from the back plate so as to have preferred heat dissipating affect by heat convection. Furthermore, the motherboard is installed on the seat and at the open space “a” between the frame supporter and the back plate. A motherboard of any type is suitable, such as a two kernel CPU or other motherboard with high operation speed. Thus the space is enough for installing motherboards of various sizes and for upgrading. Background of the invention

### BACKGROUND OF THE INVENTION

In current computer device, a casing is used to assemble the motherboard, data processing unit, interface cards, power supplies and heat dissipating devices. The arrangement of the devices in the computer casing will deeply affect the heat convection and the specifications of the devices. Thus a preferred space arrangement of the computer casing will promote the space arrangement, suitable specification, and heat dissipating efficiency so that various devices of different specifications can be used in the computer.

Referring to FIG. 1, a prior art computer casing is illustrated. A panel frame 11 is installed at a front side of the casing 10. The panel frame 11 is a pivotal doorplate 12 and a plurality of via holes 13. A rear side of the panel frame is installed with a supporter 14 for disk drive. A plurality spacers 16 for fans, a motherboard (not shown) at the rear space of the spacers 16, and a back plate 17 are sequentially arranged. A plurality of interface card slots are formed on the back plate 17.

The prior art has the following defects.

The panel frame 11 has a plurality of via holes 13. A fan 15 can guide exterior air to blow the motherboard through the via hole 13. However the amount of air is insufficient and is hindered by the supporter 14. Thus the heat dissipating effect is not preferred. Furthermore, lower frequency noise will generate due to the air flowing.

Moreover, the spacers 16 are positioned on the supporter 14. The spacers 16 are retained with predetermined spacing so as to provide sufficient space for airflow. As a result, the space between the spacer 16 and the back plate 17 is confined. Thus, only motherboards of small sizes can be used. Large and powerful motherboards (such as two kernel motherboards) cannot be used. Thus the space margins for installing motherboards are confined. Thereby the heat dissipating effect is not good.

### SUMMARY OF THE INVENTION

Accordingly, the primary object of the present invention is to provide an industrial computer casing, wherein the fan module can guide exterior cool air to the motherboard and then flow out from the back plate so as to have preferred heat dissipating affect by heat convection. Furthermore, the motherboard is installed on the seat and at the open space a between the frame supporter and the back plate. A motherboard of any type is suitable, such as a two kernel CPU or other mother board with high operation speed. Thus the space is enough for installing motherboards of various sizes and for upgrading.

To achieve above objects, the present invention provides an industrial computer casing which comprises a seat; a front frame at a front side of the seat and formed with a frame hole and a long hole at an upper side of the frame hole; a door plate covering upon a front end of the front frame; the door plate having a plurality of via holes; a tray installed with a data processing unit; the tray passing through the long hole and running across the frame supporter and the supporting plate so as to be positioned at an upper front side of the casing; and a back plate at a backside of the seat; a mother board installed on the seat and in an open space a between the frame supporter and the back plate; an upper cover covering upon the seat.

The various objects and advantages of the present invention will be more readily understood from the following detailed description when read in conjunction with the appended drawing.

### BRIEF DESCRIPTION OF THE DRAWINGS

FIG. 1 is a perspective view of a prior art computer casing.

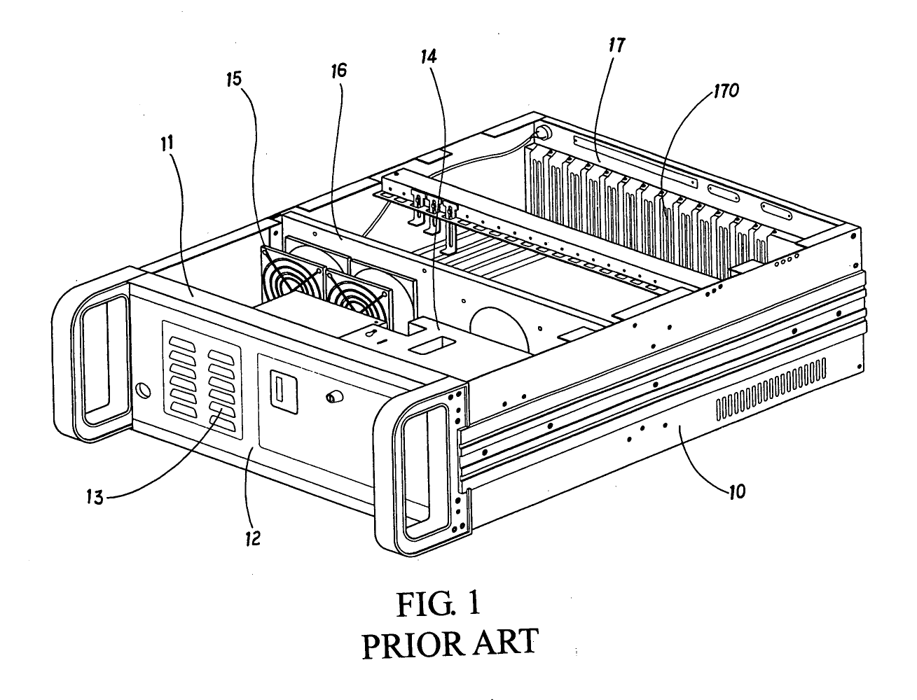

FIG. 2 is an exploded perspective view of the present invention.

FIG. 3 is a perspective view of a front frame of the present invention.

FIG. 4 is an assembled view of the present invention.

FIG. 5 is an elevation view of the present invention.

FIG. 6 is a rear view of the present invention.

FIG. 7 is a schematic view showing the guiding of air according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

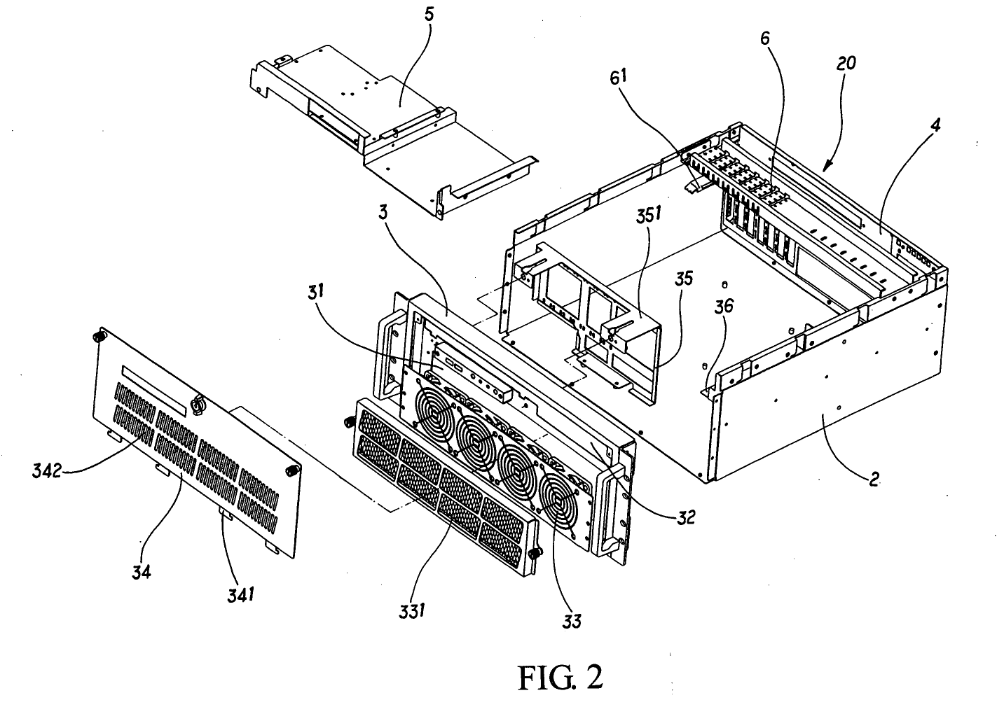

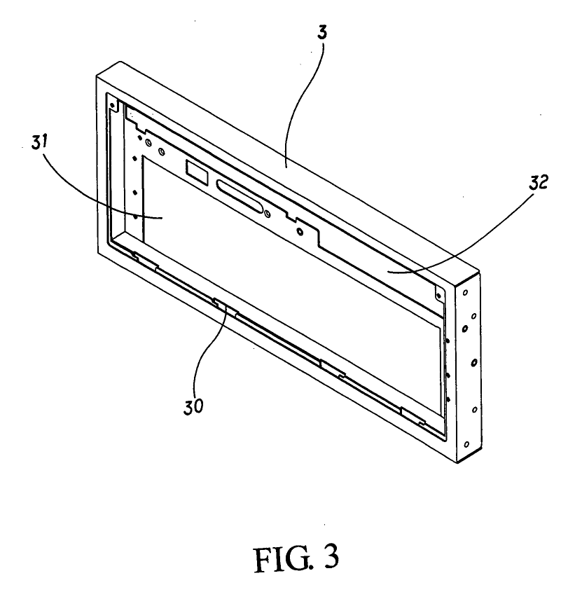

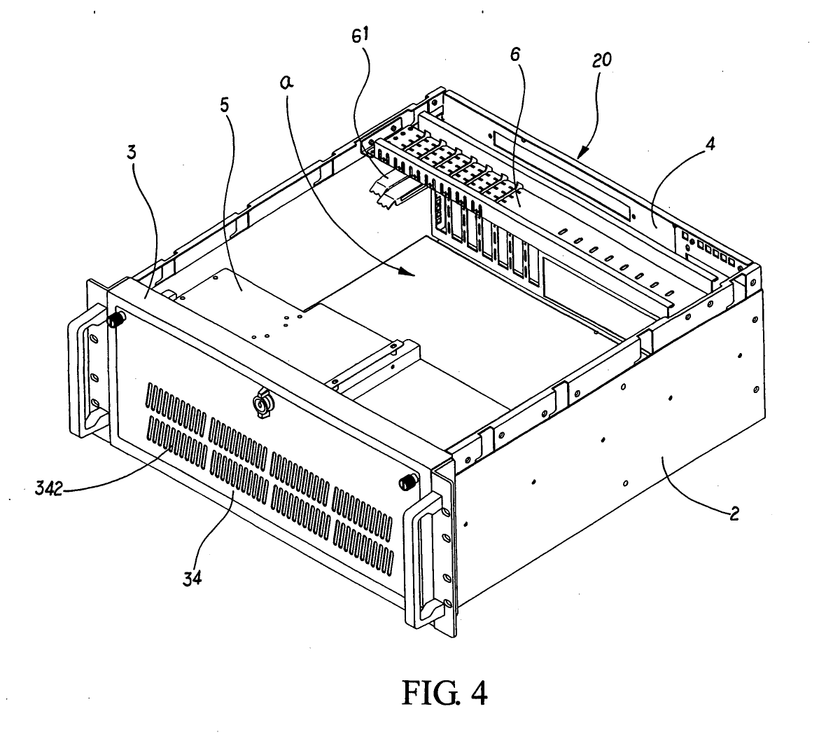

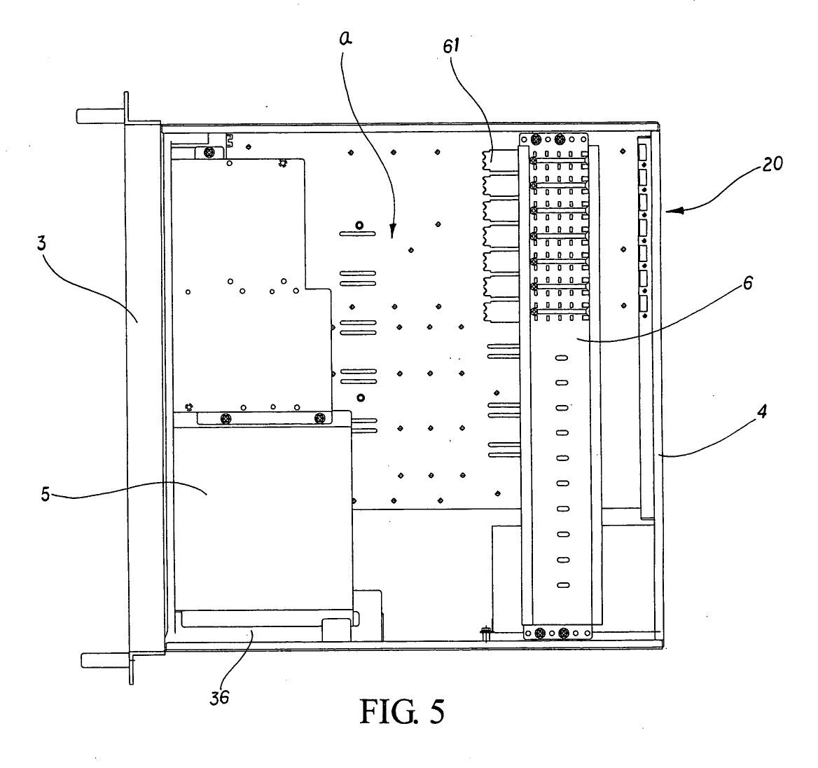

With referring to FIGS. 2 to 5, an industrial computer casing is illustrated. The casing 20 has the following elements.

A seat 2 is included.

A front frame 3 is at a front side of the seat 2 and is formed with a frame hole 31 and a long hole 32 at an upper side of the frame hole 31. A fan module 33 is installed in the frame hole 31.

A door plate 34 covers upon a front end of the front frame 3. A lower side of the door plate 34 is installed with a plurality of rotary shafts 341 which can be inserted into a plurality of through holes 30 at a lower side of the front frame 3 so that the door plate 34 is rotatably installed to the front side of the casing 20 and exactly covers upon the front frame 3. The door plate 34 has a plurality of via holes 342.

A filter net 331 is installed at a front side of the fan module 33. The filter net 331 is positioned at a backside of the via holes 342 of the door plate 34. Thus the fan module 33 in the frame hole 31 guides outer cool air to enter into the casing from the via holes 342 to blow the interior of the casing 20.

A frame supporter 35 is at one side of a backside of the front frame 3.

A supporting plate 36 is at another side of the backside of the front frame 3. The supporting plate 36 is firmly secured at an upper side of the seat 2.

A tray 5 is installed with a data processing unit 5 1. The tray 5 passes through the long hole 32 and runs across the frame supporter 35 and the supporting plate 36 so as to be positioned at an upper front side of the casing 20.

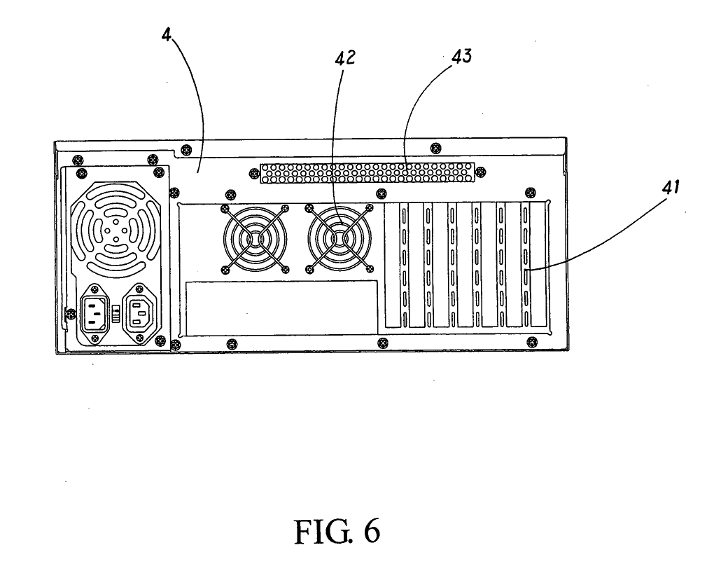

A back plate 4 is at a backside of the seat 2 (referring to FIG. 6). The back plate 4 has a plurality of slots 41 for receiving interface cards. At least one fan 42, a plurality of heat dissipating holes 43 and a power supply 44 are installed on the back plate 4. An upper back side of the seat 2 has a press strip 6. A plurality of press plates 61 are installed on the press strip 6. A motherboard 7 is installed on the seat 2 and in an open space “a” between the frame supporter 35 and the back plate 4. The press plates 61 serves to press the interface cards 71 in the motherboard 7. An upper cover covers upon the seat 2.

Above mentioned components are formed as the casing 20 of the present invention.

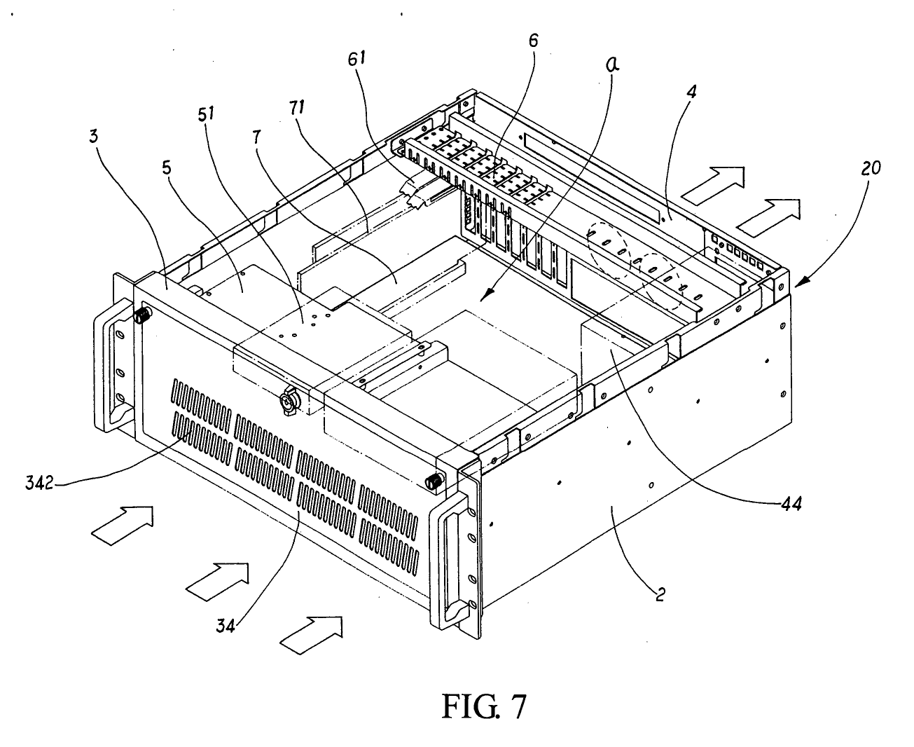

By above mentioned structure, the tray 5 with the data processing unit 51 passes through the long hole 32 to be positioned at the upper front end of the casing 20 and the tray 5 is slideable in the long hole 32. Preferably, the fan module 33 can guide exterior cool air to the motherboard 7 (referring to FIG. 7) and then flow out from the back plate 4 so as to have preferred heat dissipating affect by heat convection. Furthermore, the motherboard 7 is installed on the seat 2 and at the open space “a” between the frame supporter 35 and the back plate 4. A motherboard of any type is suitable, such as a two kernel CPU or other motherboard with high operation speed. Thus the space is enough for installing motherboards of various sizes and for upgrading.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An industrial computer casing comprising:
a seat;
a front frame at a front side of the seat and formed with a frame hole and a long hole at an upper side of the frame hole;
a door plate covering upon a front end of the front frame; the door plate having a plurality of via holes;
a tray installed with a data processing unit; the tray passing through the long hole and running across the frame supporter and the supporting plate so as to be positioned at an upper front side of the casing; and
a back plate at a backside of the seat; a motherboard installed on the seat and in an open space between the frame supporter and the back plate; and an upper cover covering upon the seat.

2. The industrial computer casing as claimed in claim 1, wherein a fan module is installed in the frame hole; a filter net is installed at a front side of the fan module; the filter net is positioned at a backside of the via holes of the door plate; thus the fan module in the frame hole guides outer cool air to enter into the casing from the via holes to blow the interior of the casing.

3. The industrial computer casing as claimed in claim 1, wherein a lower side of the door plate is installed with a plurality of rotary shafts which can be inserted into a plurality of through holes at a lower side of the front frame so that the door plate is rotatably installed to the front side of the casing and exactly covers upon the front frame.

4. The industrial computer casing as claimed in claim 1, wherein an upper back side of the seat has a press strip; a plurality of press plates are installed on the press strip and the press plates serves to press the interface cards in the motherboard

5. The industrial computer casing as claimed in claim 1, wherein the back plate has a plurality of slots for receiving interface cards; and at least one fan, and a plurality of heat dissipating holes and a power supply are installed on the back plate.

6. The industrial computer casing as claimed in claim 1, wherein a frame supporter is at one side of a backside of the front frame; and a supporting plate is at another side of the backside of the front frame; and the supporting plate is firmly secured at an upper side of the seat.
